(19) United States
(12) Patent Application Publication
(10) Pub. No.: US 2020/0356340 A1
(43) Pub. Date: Nov. 12, 2020

(54) CONVERSION OF NON-VERBAL COMMANDS

(71) Applicant: Hewlett-Packard Development Company, L.P., Spring, TX (US)

(72) Inventor: David H Hanes, Fort Collins, CO (US)

(73) Assignee: Hewlett-Packard Development Company, L.P., Spring, TX (US)

(21) Appl. No.: 16/642,111

(22) PCT Filed: Sep. 7, 2017
(86) PCT No.: PCT/US2017/050461

§ 371 Date: Feb. 26, 2020

(51) Int. Cl. G06F 3/16; G06F 3/023; G06F 3/038

(52) U.S. Cl. CPC G06F 3/167; G06F 2203/0381; G06F 3/038; G06F 3/023

(57) ABSTRACT

An example audio/visual (A/V) headset device comprises an actuator to transmit signals corresponding to a first non-verbal command to a processor of the A/V headset device. In response to the signals corresponding to the first non-verbal command, the processor to convert the first non-verbal command to a second non-verbal command. The processor is also to transmit the second non-verbal command to a computing device.

### BACKGROUND

In certain types of situations, audio/visual (A/V) devices can be used in human-to-human, human-to-machine, and machine-to-human interactions. Example A/V devices can include audio headsets, augmented reality/virtual reality (AR/VR) headsets, voice over Internet Protocol (VoIP) devices, video conference devices, etc.

### BRIEF DESCRIPTION OF THE DRAWINGS

Various examples will be described below by referring to the following figures.

FIG. 1 is a schematic illustration of an example A/V device;

FIG. 2 is a schematic illustration of an example A/V device connected to an example computing device;

FIG. 3 is a schematic illustration of an example computing device connected to an example A/V device;

FIG. 4 is a flowchart illustrating an example method for converting non-verbal commands; and

FIG. 5 is a flowchart illustrating an example method for muting audio signals to and/or from a particular program.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration.

### DETAILED DESCRIPTION

A/V devices may be usable to transmit audio between users, and may also be used to transmit audio between a user and a computing device. For example, an audio headset may be used by a user to give verbal commands to a digital assistant of a computing device. If an A/V device is used substantially concurrently for various human-to-human, human-to-machine, and/or machine-to-human interactions, there may be challenges in directing the respective audio signals to a desired recipient. For instance, a verbal command intended for a digital assistant of a computing device may also be unintentionally directed to other participants on a teleconference.

At times, therefore, interaction among users of computing devices occurs verbally. For example, electronic voice calls (e.g., VoIP), video conferencing, etc. are frequently used in business and personal communications. At times, interactions between a particular user and a computing device can also occur verbally. For instance, speech recognition tools such as DRAGON DICTATION by NUANCE COMMUNICATIONS, INC., and WINDOWS SPEECH RECOGNITION included in WINDOWS operating systems (by MICROSOFT CORPORATION) allow access to functionality of computing devices without necessarily using peripheral devices, such as a keyboard or a mouse. Furthermore, digital assistants, such as CORTANA from MICROSOFT CORPORATION, SIRI from APPLE, INC, GOOGLE ASSISTANT from GOOGLE, INC, and ALEXA from AMAZON.COM, INC, provide a number of ways for computing devices to interact with users, and users with computing devices, using verbal commands. Nevertheless, verbal interactions are at times complemented by legacy interactive approaches (e.g., keyboard and mouse), such as to interact with a computing device or a digital assistant of an electronic device.

In the context of verbal commands, it may be a challenge to direct verbal commands to a desired recipient. For instance, directing voice commands to an electronic voice call or video conference call versus a digital assistant may present challenges. For instance, in one case, while on a video conference call, an attempt to use CORTANA may be performed using a verbal command (e.g., “Hey Cortana”). Signals encoding the voice command may be received by both the program running the video conference call and also by the CORTANA program running in the background. Consequently, participants of the video conference call may hear the “Hey Cortana” command before CORTANA mutes audio input (e.g., from the microphone) into the video conference. Voice commands while on a voice or video call may be distracting or otherwise undesirable. However, in cases where the user happens to be far away from the keyboard or mouse (or the keyboard and mouse are otherwise unavailable), voice commands may be the most expedient method for accessing CORTANA. There may be a desire, therefore, for a method of directing voice commands to a desired recipient program. There may also be a desire to direct voice commands without necessarily installing an application on a computing device (e.g., a program for handling directing audio signals to programs of the computing device). For instance, there may be a desire to limit the applications or programs installed on a computing device.

In the following, transmission of verbal and non-verbal commands using an A/V device is discussed. As used herein, an A/V device is a device that can receive or transmit audio or video signals or that can receive audio or video signals from a user. One example A/V device is a head-mounted A/V device, such as an audio headset that may be used in conjunction with a computing device. As used herein, a computing device refers to a device capable of performing processing, such as in response to executed instructions. Example computing devices include desktop computers, workstations, laptops, notebooks, tablets, mobile devices, and smart televisions, among other things.

It may be possible to instruct computing devices to perform desired functionality or operation by sending a command. Commands refer to instructions that when received by an appropriate computer-implemented program or operating system are associated with a desired functionality or operation. In response to the command, the computing device will initiate performance of the desired functionality or operation.

The present discussion distinguishes between verbal and non-verbal commands. Verbal commands refer to commands transmitted to a computing device via sound waves, such as comprising speech. Non-verbal commands are those given other than using sound waves. Thus, for example, mouse movement, clicks, keyboard keypresses, or gestures are non-limiting examples of non-verbal commands.

Returning to the challenge of directing audio signals, in one case it may be possible to use a non-verbal command to facilitate direction of subsequent verbal commands to a desired program. For instance, one method for directing non-verbal commands to a computing device using an A/V device may comprise use of an actuator of the A/V device and a processor to convert a first command to a second command. In one case, an A/V device, may include a processor to convert signals representing a non-verbal command (e.g., a button press) in one form into signals representing a non-verbal command (e.g., a keyboard keypress or combination of keypresses) in a second form. The signals representing the non-verbal command may be such that they may be received and/or interpreted by a computing device without additional software.

To illustrate, for some computing devices running a WINDOWS operating system (e.g., WINDOWS 10), putting CORTANA in listening mode may be done using the keyboard keypress combination (e.g., a shortcut) of the Windows key plus ‘C’. It may be desirable to input this keyboard keypress combination using by an A/V device (e.g., a headset) to provide a non-verbal command (e.g., such as to put CORTANA in listening mode) to a computing device. Subsequently, verbal commands may be provided using the A/V device.

Therefore, in one example case, if a user is in an audio or video call, the button press may allow the user to provide a verbal command without that command being heard by other participants in the audio or video call. That is, a non-verbal command may be used to assist in directing a subsequent verbal command to a desired recipient program (e.g., a digital assistant). And by converting a first non-verbal command to a second non-verbal command at the A/V device, additional software for directing verbal commands at the computing device may be avoided. Subsequent to the verbal commands to the recipient program, audio signals may again be provided to the audio or video call.

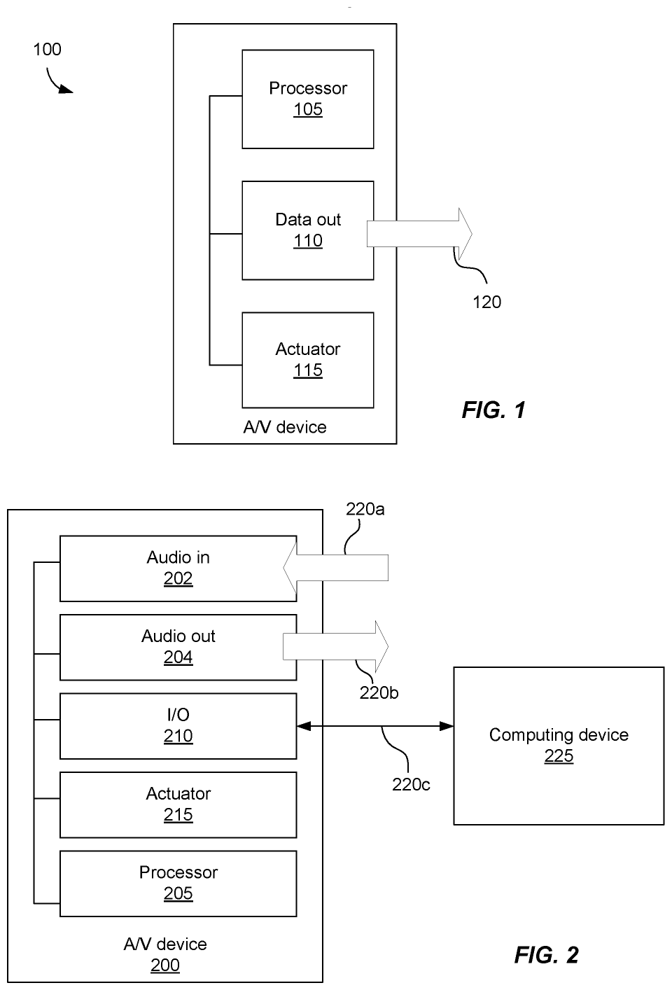

FIG. 1 illustrates a sample A/V device 100 comprising a processor 105, an actuator 115, and a component for data output 110. Example A/V device 100 may be capable of converting a first non-verbal command (e.g., a button press) into a second non-verbal command (e.g., a keyboard keypress). As noted above, an A/V device refers to a device, such as a headset, capable of transmitting receiving audio or visual signals to and/or receiving audio or visual signals.

Processor 105 comprises hardware, such as an integrated circuit (IC) or analog or digital circuitry (e.g., transistors) or a combination of software (e.g., programming such as machine- or processor-executable instructions, commands, or code such as firmware, a device driver, object code, etc.) and hardware. Hardware includes a hardware element with no software elements such as an application specific integrated circuit (ASIC), a field programmable gate array (FPGA), etc. A combination of hardware and software includes software hosted at hardware (e.g., a software module that is stored at a processor-readable memory such as random access memory (RAM), a hard disk or solid state disk, resistive memory, or optical media such as a digital versatile disc (DVD), and/or executed or interpreted by a processor), or hardware and software hosted at hardware.

In one case, processor 105 may be used to convert non-verbal commands. For instance, processor 105 may be capable of executing instructions, such as may be stored in a memory of A/V device 100 (not shown) to convert a first non-verbal command into a second non-verbal command. In one case, for example, processor 105 may be capable of consulting a mapping of non-verbal commands in order to perform a conversion of non-verbal commands. For instance, a look up table may be used in order to convert a particular non-verbal command, such as a button press, into a second non-verbal command, such as a keyboard keypress combination. Processor 105 may also enable transmission of the second non-verbal command to a computing device. In one case, processor 105 may transmit the second non-verbal command (e.g., in the form of digital signals) via an interface module (e.g., comprising an output port). FIG. 1 includes a block labeled data out 110 via which signals 120 are transmitted, such as to a computing device. In one case, data out 110 may comprise a universal serial bus (USB) controller. In another case, data out 110 may comprise a WIFI component or a BLUETOOTH component by way of non-limiting example. As such, data out 110 represents a component of A/V device 100 capable of transmitting signals, such as to a computing device.

Actuator 115 comprises a component capable of enabling generation of signals indicative of a non-verbal command. In one example case, actuator 115 may comprise a button, and a signal may be generated when the button is actuated. For instance, the button may act as a switch, actuation of which may close a circuit and transmit a signal to processor 105. Actuator 115 may comprise other components, such as sliders or toggles, by way of non-limiting example. In another example, actuator 115 may comprise a plurality of actuators.

In an example case in which A/V device 100 comprises a headset, operation thereof may comprise actuation of actuator 115. Actuator 115 may comprise a button, and actuation thereof may comprise pressing the button. Responsive to actuation, signals may be transmitted from actuator 115 to processor 105. The transmitted signals may be indicative of a first non-verbal command. The first non-verbal command may comprise, for example, a button press.

Processor 105 may convert the first non-verbal command to a second non-verbal command. For instance, in one case, actuation of actuator 115 may be mapped to a particular keyboard keypress, and processor 105 may transmit signals representative of the keyboard keypress, which may be a second non-verbal command, such as to a computing device. If A/V device 100 is connected to a computing device via a USB connection, then the signals representative of the second non-verbal command may be transmitted via data out 110 to a computing device, as illustrated by signals 120. Using a USB-based mode of transmission, signals may be transmitted between data out 110 and a USB component of the computing device. If A/V device 100 is connected to a computing device via a wireless connection, such as a BLUETOOTH connection, then the signals representative of the second non-verbal command may be transmitted wirelessly via data out 110 to a computing device, such as illustrated by signals 120.

As noted above, conversion of the first non-verbal command to the second non-verbal command may comprise referring to a look up table or may comprise consulting a user-programmable mapping between non-verbal commands, by way of example. To illustrate, several example mappings could include a mapping of actuation of actuator 115 to a keyboard keypress for putting CORTANA in listening mode (e.g., Windows+C), a keyboard keypress for initiating DRAGON DICTATION “press-to-talk” mode (e.g., the ‘0’ key on the number pad), putting SIRI into listening mode (e.g., command+space), etc. It should be noted, however, that the present disclosure is not limited to mappings to keyboard keypresses. Indeed, potential mappings could include actuator-to-mouse clicks or gestures, actuator-to-pen swipes or gestures, or actuator-to-touch touches or gestures, by way of non-limiting example. Therefore, as should be appreciated, a number of possible implementations of non-verbal command conversion are contemplated by the present disclosure.

FIG. 2 illustrates an implementation of an example A/V device 200 connected to an example computing device 225. In this example, A/V device 200 includes audio in 202 and audio out 204. In a case in which A/V device 200 is a headset, audio in 202 may comprise a microphone for converting sound waves into electrical signals. For instance, arrow 220a illustrates sound waves coming in to audio in 202. Audio in 202 can convert the sound waves represented by arrow 220a into electrical signals to be transmitted to processor 205. The audio signals from audio in 202 may be transmitted through an input/output component, I/O 210, to computing device 225. Converted sound waves (e.g., audio signals) transmitted to computing device 225 may be received as input into a program running on computing device 225, such as a video conference program.

Audio out 204 may comprise a speaker capable of converting audio signals into sound waves. For instance, arrow 220b illustrates sound waves exiting A/V device 200, such as generated by audio out 204. In one example case, audio signals, such as from a program running on computing device 225, may be transmitted to A/V device 200 (e.g., represented by signals indicated by arrow 220c) and received by audio out 204. The audio signals may be converted into audio waves by audio out 204, such as an electrostatic transducer by way of non-limiting example. To illustrate with an example, audio signals may be transmitted from computing device 225 and audio out 204 may convert the audio waves into sound waves, such as may be audibly perceptible to a user.

Actuator 215 and processor 205 may operate similarly to actuator 115 and processor 105 in FIG. 1. I/O 210 represents a component or set of components for transmitting and receiving signals. In one example, I/O 210 may enable transmission of audio signals to computing device 225, such as via a wired or wireless connection. In another example, I/O 210 may enable reception of audio signals from computing device 225, such as via a wired or wireless connection.

In operation, one implementation of A/V device 200 may enable transmission of audio and sound waves between A/V device 200 and computing device 225. For instance, A/V device 200 may be used as part of an audio call in which audio signals are transmitted to computing device 225 and audio signals are received from computing device 225. At a point during the audio call, actuator 215 may be actuated, and signals indicative of a first non-verbal command (e.g., a button press) may be transmitted to processor 205. Processor 205 may convert the signals indicative of the first non-verbal command into signals indicative of a second non-verbal command (e.g., a keyboard keypress). For example, processor 205 may map the first non-verbal command to a second non-verbal command, such as a keyboard shortcut keypress combination to launch (or put into a listening mode) a digital assistant on computing device 225. The second non-verbal command may be transmitted to the computing device for handling by a computer executed program. Subsequently, verbal commands may be given to the digital assistant without necessarily sending the verbal commands to participants of the audio call.

As should be appreciated, a number of possible implementations of A/V device 200 may be realized consistently with the foregoing discussion. For example, in addition to the example of an audio headset usable for audio interactions with a computing device, AR/VR headsets, smart TVs and remotes, smart speakers and smart speaker systems, etc. may operate in a similar fashion consistent with the present disclosure.

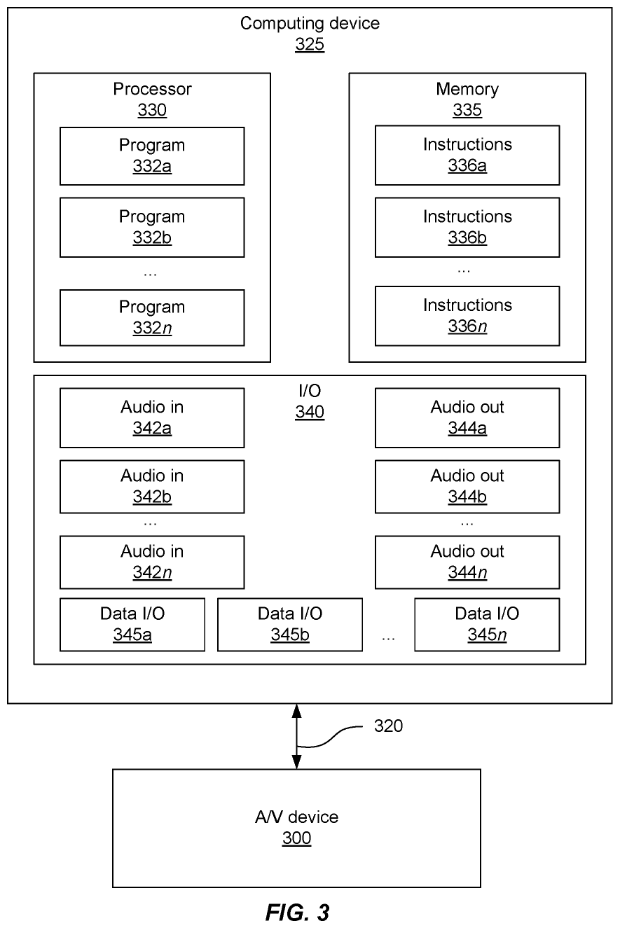

FIG. 3 is a block diagram illustrating operation of the present disclosure from the perspective of a computing device, computing device 325. Computing device 325 may comprise a memory 335 capable of storing signals and/or states. For instance, memory 335 may comprise random access memory (RAM) or read only memory (ROM), by way of example, accessible by processor 330. Memory 335 may comprise non-transitory computer readable medium. Instructions may be fetched from memory 335 and executed by processor 330 to instantiate programs or applications, which are referred to interchangeably herein. The programs comprise logical processes set out by the instructions implemented by computing device 325, and thereby achieve desired functionality (e.g., perform a calculation, display an image, play a sound, etc.). Memory 335 may comprise a number of possible sets of instructions (e.g., instructions 336a, 336b, . . . , 336n) which, when executed by processor 330, may yield an equal (or greater) number of instances of a program (e.g., program 332a, 332b, . . . , 332n).

In the present disclosure, computing device 325 may have an I/O component, I/O 340, which, similar to I/O 210 in FIG. 2, may be capable of enabling transfer and reception of signals to and from computing device 325. Among signals transferred to and from computing device 325 are audio signals. A particular computing device may have the ability to send and receive a number of concurrent audio signals. For instance, a particular computing device may have a number of audio input ports and a number of audio output ports. An audio input signal from a particular port may be replicated and/or otherwise transmitted to different programs or components of computing device 325. Thus, audio signals from a microphone may be transmitted to a program doing voice dictation, a digital assistant program, and a VoIP program by way of non-limiting example. Similarly, a number of different audio signals (e.g., from a plurality of different programs) may be combined on a particular audio output port. For instance, audio signals from a number of programs of computing device 325 may be combined and transmitted via an output port, such as audio out 344a.

FIG. 3 illustrates a number of audio inputs, audio in 342a, 342b, . . . , 342n, and a number of audio outputs, audio out 344a, 344b, . . . , 344n. I/O 340 may also comprise a number of data input/output ports, such as data I/O 345a, 345b, . . . , 345n. It should be appreciated that in some cases, and according to some protocols, audio input, audio output, and data I/O may be combined at a common port. By way of example, electrical signals transmitted over a USB port may comprise encoded data and audio signals. Similarly, BLUETOOTH, which comprises a data layer and a voice layer for transmission of data and voice signals, respectively is an example I/O 340 combining audio I/O and data I/O. Of course, voice signals may be converted to binary digital signals, and transmitted and received over the data layer.

Computing device 325 may operate in relation to A/V device 300 similarly to operation of computing device 225 in relation to A/V device 200. For example, computing device 325 may receive audio signals from and transmit audio signals to A/V device 300. Processor 330 of computing device 325 may be similar in function to processor 205 of FIG. 2. For example, processor 330 may be capable of executing instructions to achieve functionality and operation of computing device 325. By way of non-limiting example, instructions 336a may be fetched from memory 335 and executed by processor 330. An instance of a program 332a may be instantiated responsive to the execution. In one case, program 332a may comprise a program for voice calling (e.g., VoIP) or video conferencing. In this example case, audio signals may be received from A/V device 300 via an audio input (e.g., an audio port), such as audio in 342a. And audio signals may be transmitted to A/V device 300 via an audio output (e.g., an audio output port), such as audio out 344a. As noted above, at times, both audio input and audio output may occur over a same port or connection, such as may be the case with certain wired (e.g., USB) and wireless (e.g., BLUETOOTH) connection protocols.

An actuator of A/V device 300 (e.g., actuator 215 of FIG. 2) may facilitate transmission of a non-verbal command to computing device 325. For example, if the non-verbal command is a keyboard keypress (e.g., Windows+C), the non-verbal command may be received by computing device 325 (e.g., via I/O 340) and may be received by a program (e.g., program 332b) and handled as computing device 325 would handle the respective non-verbal command (e.g., a keyboard keypress). Thus, for a keyboard keypress, such as Windows+C, the operating system (OS) of computing device 325 may receive the keypress (e.g., non-verbal command) and handle according to a shortcut key mapping (e.g., putting CORTANA into listening mode).

In addition, an audio manager program or application may be running on computing device 325 in order to enable muting particular audio signal lines, such as to and from other programs. For example, the audio manager program may be capable of determining whether any programs or applications running on computing device 325 are receiving or transmitting audio signals. And, in response to an actuator of A/V device 300, the audio manager program may mute a particular audio signal line. For instance, if an audio call (e.g., VoIP) is conducted using a program of computing device 325, in response to actuation of an actuator of A/V device 300, the audio manager program may mute an audio signal from a microphone of A/V device 300 as transmitted to the program running the audio call. Of course, there may still be a desire to use audio signals from the microphone in other programs (e.g., with a digital assistant running on computing device 325), and thus, muting of one audio signal line may not necessarily mute that line for all programs. For instance, audio signals from the microphone may be desired in order to interact with a digital assistant, but may also be muted as to another program (e.g., a video conference program).

Another example program running on either processor 330 of FIG. 3 or processor 205 of FIG. 2 may include a program to enable user-defined mapping of non-verbal commands. For instance, the program may retrieve a current mapping of non-verbal commands, and may allow the mapping to be updated. For an A/V headset with an actuator, signals indicative of a mapping may be retrieved. The mapping may be updated and stored in a memory of the A/V headset. And upon actuation of the actuator, signals corresponding to the updated mapping may be sent to the computing device.

In one implementation, computing device 325 may recognize A/V device 300 as two distinct devices to enable transmission of a converted non-verbal command (e.g., such as in response to installation of a driver for A/V device 300). For instance, A/V device 300 may be recognized as both an audio headset and a USB keyboard. Thus, in the case of a USB device, actuation of an actuator of the headset may be converted and the converted signals sent to computing device 325 as from a USB keyboard. Likewise, the converted signals may be received by computing device 325 as from a USB keyboard.

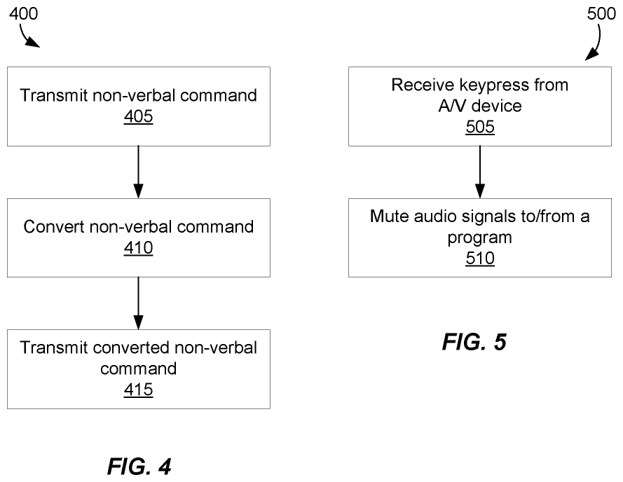

Turning to FIG. 4, an example process 400 is illustrated for converting from one non-verbal command to a second non-verbal command and transmitting the converted non-verbal command to a computing device. At block 405, a non-verbal command is transmitted. As discussed above in relation to FIGS. 1-3, actuation of an actuator may trigger transmission of signals representative of a non-verbal command. At times, for example, the non-verbal command may comprise a button press. The button press may correspond to a desired functionality, such as putting a digital assistant in a listening mode. The button press correspondence with the desired functionality may be user-editable. For example, a program running on a computing device may enable an alteration of mapping between button press and desired functionality. In another example, the mapping may be altered at the A/V device, such as by use of a programming button.

Returning to FIG. 4, responsive to transmission of the non-verbal command to a processor of the A/V device, the processor may convert the non-verbal command (e.g., a first non-verbal command) to a converted non-verbal command (e.g., a second non-verbal command). For instance, using a mapping, the initial non-verbal command corresponding to a button press may be converted to a second non-verbal command corresponding to a keyboard keypress. The conversion of non-verbal commands may comprise conversion of signals in a first form, such as electronic signals indicative of a button press at an A/V device, into a second form representative of a second non-verbal command, which is different from the first non-verbal command. For example, the second form may comprise electronic signals indicative of a keyboard keypress.

At block 415, the converted non-verbal command is transmitted to a computing device. As discussed above, the converted non-verbal command may be representative of a keyboard keypress. Signals representative of the converted non-verbal command may be transmitted via a wired or wireless connection with the computing device. In one example case, the signals may be transmitted between an A/V device and a computing device via a USB connection.

FIG. 5 illustrates an example method 500 for muting signals of a program. As noted above, at times, it may be desirable to mute or otherwise impede signals sent to a particular program responsive to actuation of an actuator of an A/V device. For example, if a user is using an AR/VR headset to interact in an augmented or virtual environment, there may be a desire to access a digital assistant, such as to set a reminder or an alarm, without necessarily interrupting the user interaction in the augmented or virtual environment through an AR/VR program. In one case, an actuator of the AR/VR headset may be actuated in order to access the digital assistant. Responsive to the actuation, the AR/VR headset may convert signals representative of a first non-verbal command into a second non-verbal command (e.g., a keyboard keypress) to access the digital assistant. In response to the second non-verbal command, an audio management program on the computing device may determine that audio signals from a microphone of the AR/VR headset is being used to transmit audio signals to the AR/VR program. The audio management program on the computing device may also determine that audio signals from the AR/VR program are being transmitted to the speakers of the AR/VR headset. The audio management program may determine, therefore, that the audio signals from the microphone are to be temporarily muted or otherwise impeded as to the AR/VR program in order to allow the user to provide verbal commands to the virtual assistant without also providing audio signals to the AR/VR program. Similarly, the audio management program may also temporarily mute or otherwise impede audio signals from the AR/VR program to the AR/VR headset, in order to allow the user to hear the digital assistant without interference from audio signals from the AR/VR program.

Consistent with the foregoing example, at a first block 505, signals representing a keyboard keypress may be received from an A/V device. In one example case, the signals may be indicative of a Windows+C keyboard keypress combination. In response to the received signals, an audio management program may mute audio signals to and/or from a program, such as shown at block 510.

As discussed above, therefore, an A/V device (e.g., A/V device 100 in FIG. 1, A/V device 200 in FIG. 2, A/V device 300 in FIG. 3, etc.) may be capable of converting one non-verbal command to a second non-verbal command. In one example case, the A/V device may be an A/V headset connected to a computing device via a USB connection. Due to, for example, drivers of the A/V device, the computing device may connect to the A/V device as both an A/V headset and also a keyboard.

For instance, one implementation of an A/V headset device includes an actuator to transmit signals corresponding to a first non-verbal command to a processor of the A/V headset device. In response to the signals corresponding to the first non-verbal command, the processor is to convert the first non-verbal command to a second non-verbal command. The processor is also to transmit the second non-verbal command to a computing device.

At times, the first non-verbal command comprises actuation of the actuator. In some cases, the second non-verbal command may comprise a keyboard keypress. For instance, the keyboard keypress may comprise Windows+C.

In some cases, the A/V headset device may be connected to the computing device via a wired connection, such as a USB connection. In other cases, the A/V headset device may be connected to the computing device via a wireless connection, such as a BLUETOOTH connection.

In another implementation, an A/V headset device comprises an actuator and a processor. The processor is to, in response to actuation of the actuator, convert a first signal corresponding to a first non-verbal command to a second signal corresponding to a second non-verbal command. The second signal represents a keyboard keypress in this case.

In one case, conversion of the first signal to the second signal is based on a mapping of the keyboard keypress to actuation of the actuator. In one case, the processor is further to change the mapping responsive to signals from a computing device connected to the A/V headset device.

In yet another implementation, a non-transitory computer readable medium comprises instructions that when executed by a processor of a computing device are to cause the computing device to receive a signal corresponding to a keyboard keypress from an A/V device, and mute audio output signals, audio input signals, or a combination thereof of a computer executable program running on the computing device.

In one case, the instructions are also to cause the computing device to determine default audio output devices, audio input devices, or a combination thereof of the computing device. In another case, the muting of audio output signals, audio input signals, or the combination thereof is based on the determined default audio output devices, audio input devices, or the combination thereof. In yet another case, the instructions are to cause the computing device to receive signals corresponding to a mapping of an actuator of the A/V device to the keyboard keypress, and transmit signals corresponding to an updated mapping to the A/V device.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will be apparent to those skilled in the art. It is, therefore, to be understood that the appended claims are intended to cover all modifications and/or changes as fall within claimed subject matter.

What is claimed is:

1. An audio/visual (A/V) headset device comprising:
an actuator to transmit signals corresponding to a first non-verbal command to a processor of the A/V headset device;
in response to the signals corresponding to the first non-verbal command, the processor to:
convert the first non-verbal command to a second non-verbal command; and
transmit the second non-verbal command to a computing device.

2. The A/V headset device of claim 1, wherein the first non-verbal command comprises actuation of the actuator.

3. The A/V headset device of claim 2, wherein the second non-verbal command comprises a keyboard keypress.

4. The A/V headset device of claim 3, wherein the keyboard keypress comprises a combination of keypresses.

5. The A/V headset device of claim 1, wherein the A/V headset device is connected to the computing device via a wired connection.

6. The A/V headset device of claim 5, wherein the wired connection comprises a universal serial bus (USB) connection.

7. The A/V headset device of claim 1, wherein the A/V headset device is connected to the computing device via a wireless connection.

8. An audio/visual (A/V) headset device comprising:
an actuator; and
a processor, the processor to:
responsive to actuation of the actuator, convert a first signal corresponding to a first non-verbal command to a second signal corresponding to a second non-verbal command, wherein the second signal represents a keyboard keypress.

9. The A/V headset device of claim 8, wherein conversion of the first signal to the second signal is based on a mapping of the keyboard keypress to actuation of the actuator.

10. The A/V headset device of claim 9, wherein the processor is further to change the mapping responsive to signals from a computing device connected to the A/V headset device.

11. A non-transitory computer readable medium comprising instructions that when executed by a processor of a computing device are to cause the computing device to:
receive a signal corresponding to a keyboard keypress from an audio/visual (A/V) device; and
mute audio output signals, audio input signals, or a combination thereof of a computer executable program running on the computing device.

12. The non-transitory computer readable medium of claim 11, further comprising instructions that when executed by the processor of the computing device are to cause the computing device to:
determine default audio output devices, audio input devices, or a combination thereof of the computing device.

13. The non-transitory computer readable medium of claim 12, wherein muting of audio output signals, audio input signals, or the combination thereof is based on the determined default audio output devices, audio input devices, or the combination thereof.

14. The non-transitory computer readable medium of claim 11, further comprising instructions that when executed by the processor of the computing device are to cause the computing device to:
receive signals corresponding to a mapping of an actuator of the A/V device to the keyboard keypress; and
transmit signals corresponding to an updated mapping to the A/V device.

15. The non-transitory computer readable medium of claim 11, further comprising instructions that when executed by the processor of the computing device are to cause the computing device to:
recognize the A/V device a two distinct devices.
